(19) United States
(12) Patent Application Publication
(10) Pub. No.: US 2008/0217797 A1
(43) Pub. Date: Sep. 11, 2008

(54) Simple micro concave mirror

(75) Inventor: Youngmin A. Choi, Agoura Hills, CA (US)

Correspondence Address: Youngmin Choi, 5410 Isabella Ct., Agoura Hills, CA, 91301, US

(73) Assignee: Mr. Youngmin Albert Choi, Agoura Hills, CA (US)

(21) Appl. No.: 12/070,705

(22) Filed: Feb. 21, 2008

Related U.S. Application Data
(62) Division of application No. 10/831,752, filed on Apr. 26, 2004.

(51) Int. Cl. G02B 6/10

(52) U.S. Cl. 264/1.24

(57) ABSTRACT

A novel A SIMPLE FIBER OPTIC MICRO CONCAVE MIRROR has been recognized. This mirror is formed by making a precision micro lens in a material deposited on the end of an optical fiber held in a suitable fiber ferrule. Multiple dielectric layers are applied on the lens to achieve the final, desired optical characteristic of the mirror. The concave mirror is precisely aligned to the core of the fiber. The concave lens is fabricated on the end of the fiber by making an indentation of correct geometry and smoothness.

### FIELD OF THE INVENTION

The present invention relates generally to a simple A SIMPLE FIBER OPTIC MICRO CONCAVE MIRROR. The mirror is formed by creating a spherical cavity on plastic film. The micro concave cavity is fabricated on plastic film by making an indentation of correct geometry and smoothness. The micro concave lens is precisely and easily located to the core of the fiber. The micro concave mirror is achieved by depositing multiple dielectric layers applied on the concave cavity such that the final optical characteristics are as desired. Hereafter, micro concave cavity will be considered synonymous with micro concave lens. This present invention overcomes many of the problems with other approaches due to simplicity, stability and very high yield.

### BACKGROUND OF THE INVENTION

The invention provides a novel way of creating a precision micro concave cavity on the end of an optical fiber. This micro concave cavity can be coated with layers of dielectric resulting a precision micro concave spherical mirror having very desirable properties and a multitude of uses. Current practice has many drawbacks including complexity and difficulty. For example progressive grinding and polishing are often used and are iterative in nature and thus costly, time consuming and often have low yield. Further, the use of grits and polishing compounds require special cleaning to achieve desirable surface properties. Also, these techniques have difficulty in precisely locating the apex of the cavity on the fiber core. Other techniques, like laser ablation and chemical etching, can also be used. These have similar issues to grinding and polishing and are thus complex, expensive and offer highly variable quality. The current art is a substantial departure and achieves the desired result on demand with unmatched high yield and low cost. Further, since no grits, burning or chemicals are used, the end result is more stable, requires no cleaning and with the cavity precisely located over the fiber core.

### SUMMARY OF THE INVENTION

The general purpose of the present invention, which will be described subsequently in greater detail, is to provide a novel precision micro concave cavity that can be coated with layers of dielectric resulting a precision micro concave mirror having very desirable properties and a multitude of uses.

### BRIEF DESCRIPTION OF THE DRAWINGS

Various objects, features, and attendant advantages of the present invention can be fully appreciated as the same becomes better understood when considered in conjunction with the accompanying drawings, in which like reference characters designate the same or similar parts throughout the several views, and wherein:

FIG. 1 is a schematic view of micro concave indentation in a suitable substrate material

FIG. 2 shows a concave indentation with suitable dielectric coating creating a micro concave mirror

FIG. 3 shows a method of providing a micro concave cavity on a suitable material deposited on the end of a fiber

FIG. 4 shows the interference pattern of a micro concave cavity.

### DESCRIPTION OF THE PREFERRED EMBODIMENT

Turning now descriptively to the drawings, in which similar reference characters denote similar elements throughout the several views, the attached figures illustrate novel cavities with optical fibers and two mirrors.

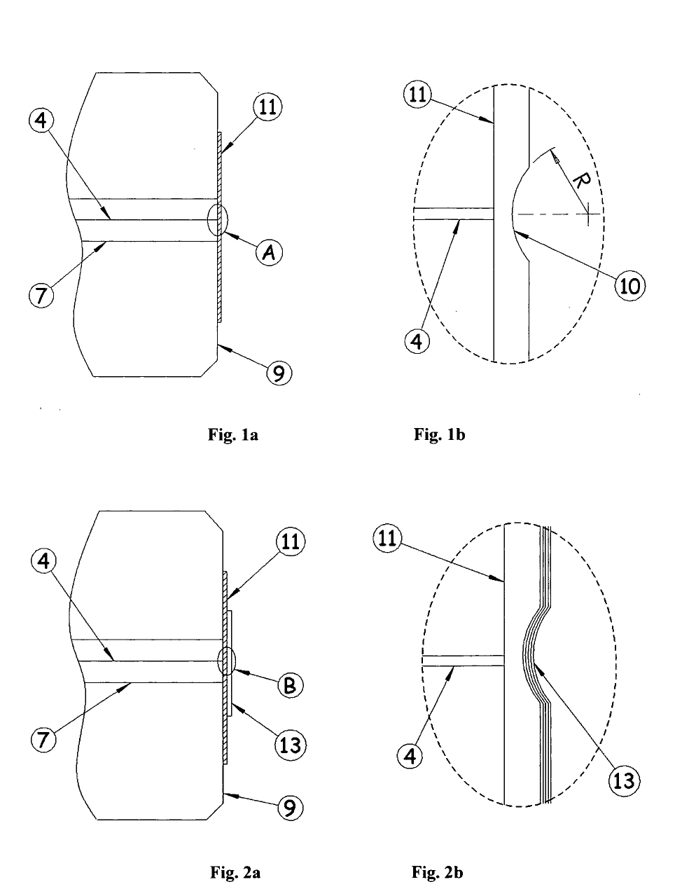

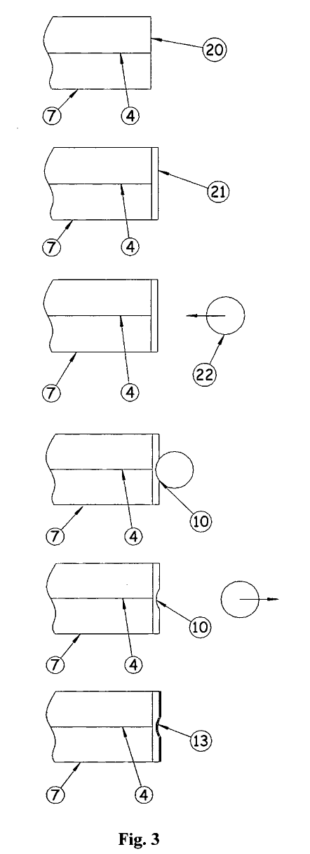

FIG. 1, shows a cavity (10) in a material (11). FIG. 2 shows this cavity (10) after dielectric coatings (13) were applied to achieve desirable optical properties. The material (11) is bonded to the ferrule (9) and the fiber (7) end such that the material surface that accepts the cavity, is flat, smooth and defect free. The cavity (10) has a radius R whose center is precisely located on the optical axis of the fiber (4) in FIG. 1. The process used is shown in detail in FIG. 3.

FIG. 1 shows a possible configuration of a spherical surface (10) of radius R, formed at the end of the optical fiber (7). The preferred embodiment utilizes a spherical concave indentation (10) on FIG. 2, the apex of which is centered on the output fiber core (4) and has deposited dielectric layers (13).

Referring to FIG. 1, a thin layer of material (11) with the desired surface and mechanical properties is bonded to the prepared end of a suitable fiber (7). FIG. 3 shows the key steps involved in creating a precision micro cavity and Mirror. The material (21), is bonded onto the end of the fiber (7) is then brought into contact with (22) in such a way as to provide an inverse replica of the profile of (22) on (21) before cavity fabrication. In addition a plethora of materials (21) could be deposited on the fiber end (20) and be subsequently processed by (22) to provide a suitable surface (10) which may or may not be subsequently re-processed by the addition of one or more layers of non-metallic or metallic coatings, either singly or in combination. During the alignment stage, light is passed down the optical fiber core (4) and is captured by (22) which has been formed on the end op an optical fiber also. By monitoring the amount of light gathered, and maximizing the amount of light, the optimal alignment is achieved. This can be done manually or automatically.

Selection of the material (item 11) is critical. This material needs to have specific physical and optical properties. Not all materials possess these desirable properties. In the current embodiment, a specific plastic film was processed to achieve a desired radius of curvature. This film was then subjected to optical measurements and dimensional stability measurements after being exposed to elevated temperature. These measurements enabled the optimal material to be selected given the criteria employed. However, this does not mean inferior materials could be used and would be outside the current scope. Nor indeed that better materials could be found and used and be outside the current scope.

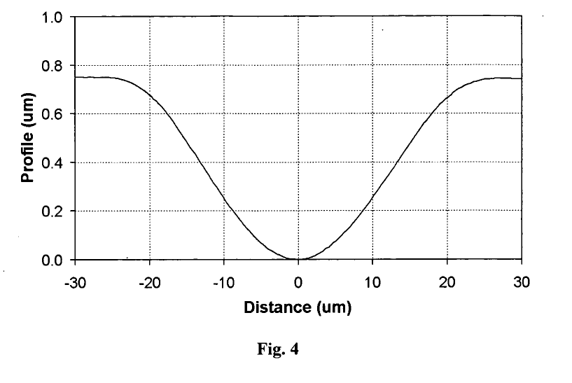

FIG. 4 shows the typical geometry of a concave lens. Upon achieving the desired radius of the curvature, it is possible to interferometrically measure the surface properties and characterize the surface. Referring again to FIG. 4, measurements of the surface show the surface roughness to be less than 6 Å, the radius of curvature to be ˜80 μm and the depth to be ˜1 μm. These are critical parameters and, as stated before, can be adjusted as desired to get the required properties. In addition to these measurements, other surfaces defects can be identified prior to depositing the mirrors and thus eliminate wasted effort on parts that will not yield.

The fiber is an amorphous structure used to guide light. The fiber (7) is composed of fused silica glass with a central core (4) of higher refractive index glass. Light is guided and bound in the core by means of the difference in refractive index between the core and the surrounding glass. In order to protect the glass a single coating or multiple coatings of protective polymer are deposited.

The mirror is a structure comprising of a surface with a desired degree of reflectivity and transmittance. The mirror (13), as seen in FIGS. 2 and 3 is composed of a dielectric coating of finite thickness and composed of multiple layers. The mirrors are deposited on the end of the optical fibers (7), which have been suitably prepared to accept such coatings and with the correct surface geometry. Typically, the fibers (7) are bonded into ferrules-(9) which allow for handling and polishing with no damage to the fiber. While fiber ferrules (9) are used in the current embodiment, this is not essential. Indeed, the ferrule does not provide any necessary function other than ease of handling.

It is also shown that the mirror (13) does not extend over the entire surface of material (11) and thus comes in contact with a face (20) on FIG. 3 and 4. Indeed, the mirror (13) need only cover surface (10) as shown by FIG. 1 and then 3. This prevents undesirable stresses at the boundary of (11) and thus inhibits cracking within the mirror construct (13). This is achieved by installing the ferrule into suitable tooling such that the desired coating area is exposed and the undesirable area is covered. When exposed through the desired aperture in the tooling, the dielectric mirror is then formed as a result of depositing multiple layers of specific properties. Further, the tooling can be designed to accommodate a number of ferrules thus reducing processing cost. The tooling can be of any desirable configuration.

After the formation of the desired mirror, the optical properties can be subsequently confirmed. Depositing the mirrors is done at an elevated temperature. This can result in the change in the shape of the curvature undesirably and thus impairing performance. However, the current process has selected specific materials and thermal deposition profiles which result in minimal distortion of the critical shape of the concave lens. This combination of materials allows for processing at higher temperatures thus resulting in an optimum mirror and lens performance and stability.

Therefore, the foregoing is considered as illustrative only of the principles of the invention. Further, since numerous modifications and changes will readily occur to those skilled in the art, it is not desired to limit the invention to the exact construction described, and accordingly, all suitable modifications and equivalents may be resorted to, falling within the scope of the invention.

What is claimed is:

1) A method of fabrication of a simple fiber optic micro concave mirror comprising;
a) A thin plastic film disposed on a fiber end;
b) The thin plastic film is optically transparent, smooth, and flat;
c) An indentation is made on the plastic film;
d) The indentation on plastic film has desired curvature and depth;
e) The indented surface is smooth for deposition of dielectric layers;
f) The apex of indentation is aligned to the core of the fiber;
g) A low loss multilayer broadband dielectric mirror disposed only on the plastic film;
h) The disposed dielectric mirror has same curvature of the indentation.
